(19) United States
(12) Patent Application Publication
(10) Pub. No.: US 2013/0004931 A1
(43) Pub. Date: Jan. 3, 2013

(54) Computer-Implemented Systems and Methods for Determining Content Analysis Metrics for Constructed Responses

(76) Inventor: Yigal Attali, Princeton, NJ (US)

(21) Appl. No.: 13/535,534

(22) Filed: Jun. 28, 2012

Related U.S. Application Data
(60) Provisional application No. 61/502,034, filed on Jun. 28, 2011.

(51) Int. Cl. G09B 7/00

(52) U.S. Cl. 434/353

(57) ABSTRACT

Systems and methods are provided for scoring speech. A speech sample is received, where the speech sample is associated with a script. The speech sample is aligned with the script. An event recognition metric of the speech sample is extracted, and locations of prosodic events are detected in the speech sample based on the event recognition metric. The locations of the detected prosodic events are compared with locations of model prosodic events, where the locations of model prosodic events identify expected locations of prosodic events of a fluent, native speaker speaking the script. A prosodic event metric is calculated based on the comparison, and the speech sample is scored using a scoring model based upon the prosodic event metric.

### CROSS-REFERENCE TO RELATED APPLICATIONS

This application claims the benefit of U.S. Provisional Patent Application No. 61/502,034 filed on Jun. 28, 2011, the entire contents of which are incorporated herein by reference.

### TECHNICAL FIELD

This document relates generally to constructed response analysis and more particularly to determining content analysis metrics for scoring constructed responses.

### BACKGROUND

Traditionally, scoring of constructed response exam questions has been an expensive and time consuming endeavor. Unlike multiple choice and true false exams, whose responses can be captured when entered on a structured form and recognized via optical mark recognition methods, more free form constructed responses, such as essays or math questions where a responder must show their work, offer a distinct challenge in scoring. Constructed responses (essays) are often graded over a wider grading scale and often involve some scorer judgment as compared to the correct/incorrect determinations that can be quickly made in scoring a multiple choice exam.

Because constructed responses are more free form and are not as amenable to discrete correct/incorrect determinations, constructed responses have traditionally required human scorer judgment that may be difficult to replicate using computers.

### SUMMARY

In accordance with the teachings herein, systems and methods are provided for scoring a constructed response. A set of training essays classified into high scored essays and low scored essays are identified. For each of a plurality of words in the training set, a number of times a word appears in high scored essays is counted, a number of times the word appears in low scored essays is counted, and a differential word use metric is calculated based on the difference. A differential word use metric value is identified for each of a plurality of words in a constructed response, and a differential word use score is calculated based on an average of differential word use metric values identified for the words of the constructed response.

As another example, in a computer-implemented method of scoring a constructed response that is provided in response to a dual prompt, words present in a listening prompt and not present in the reading prompt are identified as a listening-only words list. Words present in the reading prompt and not present in the listening prompt are identified as a reading-only words list. A first number of words in the constructed response that appear on the listening-only list are determined, and a second number of words in the constructed response that appear on the reading-only list are determined. A score for the constructed response is determined based on the first number and the second number, where the first number influences the score positively and the second number influences the score negatively.

As a further example, in a method of scoring a constructed response that is provided in response to a dual prompt, words present in the listening prompt, not present in the reading prompt, and present in a model essay are identified as an LR′M words list, words present in the listening prompt, not present in the reading prompt, and not present in a model essay are identified as an LR′M′ words list, words not present in the listening prompt, present in the reading prompt, and present in a model essay are identified as an L′RM words list, and words not present in the listening prompt, present in the reading prompt, and not present in a model essay are identified as an L′RM′ words list. A first number of words in the constructed response that appear on the LR′M list, a second number of words in the constructed response that appear on the LR′M′ list, a third number of words in the constructed response that appear on the L′RM list, and a fourth number of words in the constructed response that appear on the L′RM′ list are determined. A score for the constructed response is determined based on the first number, the second number, the third number, and the fourth number.

As a further example, in computer-implemented method of scoring a constructed response set of training essays classified into at least three scoring levels is identified, where each of the scoring levels is associated with a value. A cosine correlation is calculated between the constructed response and the training essays in each of the scoring levels. The cosine correlations are ranked for the scoring levels to identify an order for each level. A pattern cosine measure is calculated based on a sum of products of the order for a level and the value of the level, and a score for the constructed response is determined based on the pattern cosine measure.

As another example, in a computer-implemented method of scoring a constructed response, a set of training essays classified into at least three scoring levels is identified, where each of the scoring levels is associated with a weighting value. A cosine correlation is calculated between the constructed response and the training essays in each of the scoring levels. A value cosine measure is calculated based on a sum of products of the cosine correlation for a level and the weighting value of the level, and a score for the constructed response is determined based on the pattern cosine measure.

### BRIEF DESCRIPTION OF THE FIGURES

FIG. 1 is a block diagram depicting a computer-implemented constructed response scoring engine.

FIG. 2 is a block diagram depicting example details of a constructed response scoring engine.

FIG. 3 is a block diagram depicting a computer-implemented method of scoring a constructed response using a differential word use metric.

FIG. 4 is a block diagram a computer-implemented method of scoring a constructed response using a word appearance metric.

FIG. 5 is a block diagram a computer-implemented method of scoring a constructed response using a word appearance metric that considers a model response.

FIG. 6 is a block diagram depicting a determination of a pattern cosine measure based on a plurality of cosine correlation computations.

FIG. 7 is a block diagram depicting a determination of a value cosine measure based on a plurality of cosine correlation computations.

FIGS. 8A, 8B, and 8C depict example systems for use in implementing a prosodic speech feature scoring engine.

### DETAILED DESCRIPTION

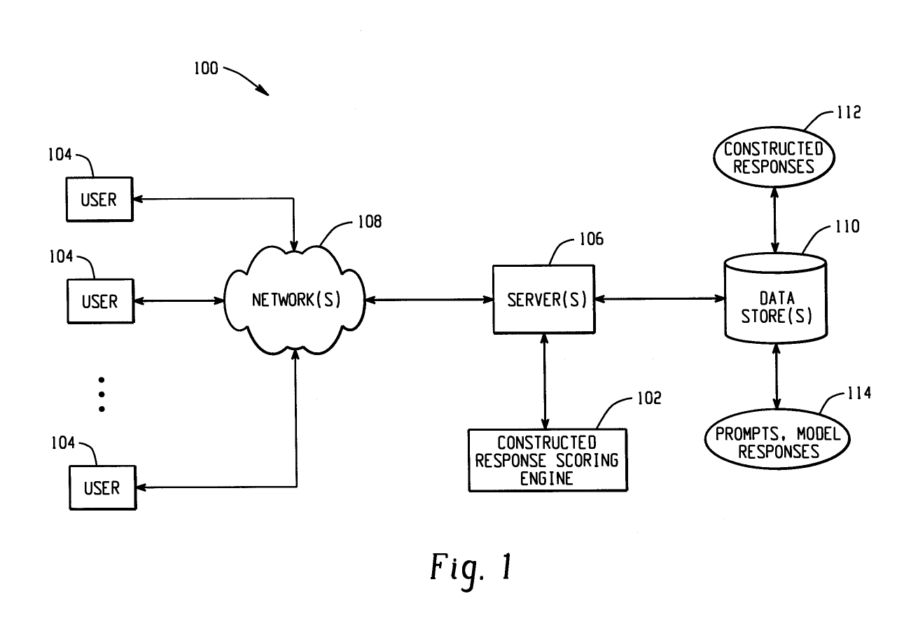

FIG. 1 is a block diagram depicting a computer-implemented constructed response scoring engine. A computer processing system implementing a constructed response scoring engine 102 (e.g., via any suitable combination of hardware, software, firmware, etc.) facilitates the scoring of constructed responses based on certain calculated content analysis metrics. Such content analysis metrics may enable comparison of a received constructed response to one or more of a prompt (listening or reading) provided to an examinee to elicit the constructed response, a scored training essay directed to the prompt, a model essay directed to the prompt, a training essay that is not directed to the prompt (e.g., a training essay that is based on a similar topic as the prompt), and other reference content.

The constructed response scoring engine 102 provides a platform for users 104 to analyze the content and/or vocabulary displayed in a received constructed response. A user 104 accesses the constructed response scoring engine 102, which is hosted via one or more servers 106, via one or more networks 108. The one or more servers 106 communicate with one or more data stores 110. The one or more data stores 110 may contain a variety of data that includes constructed responses 112 and one or more prompts, model responses, or training responses 114 used in scoring constructed responses.

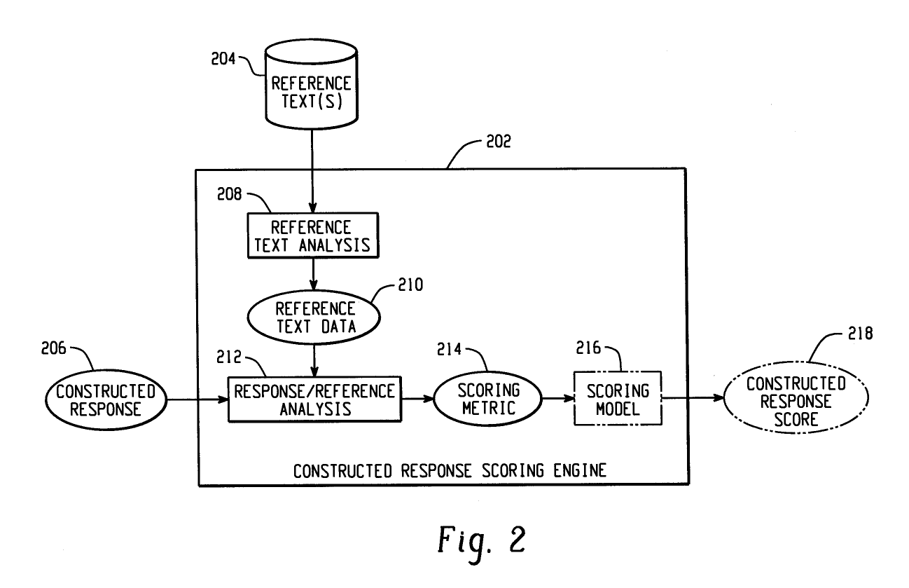

FIG. 2 is a block diagram depicting example details of a constructed response scoring engine. A constructed response scoring engine receives one or more reference texts 204 to which to compare a received constructed response 206. The constructed response scoring engine 202 performs an analysis 208 of the reference texts 204 to generate reference text data 210. The constructed response 206 is analyzed with respect reference text data 210 to generate a scoring metric 214. The scoring metric 214 may alone be indicative of the quality of the constructed response 206 and stored or provided to interested parties. Additionally, the scoring metric 214 may be provided as an input to a scoring model 216 that receives other inputs (e.g., other scoring metrics), such that a constructed response score 218 is generated in part based on the scoring metric 214.

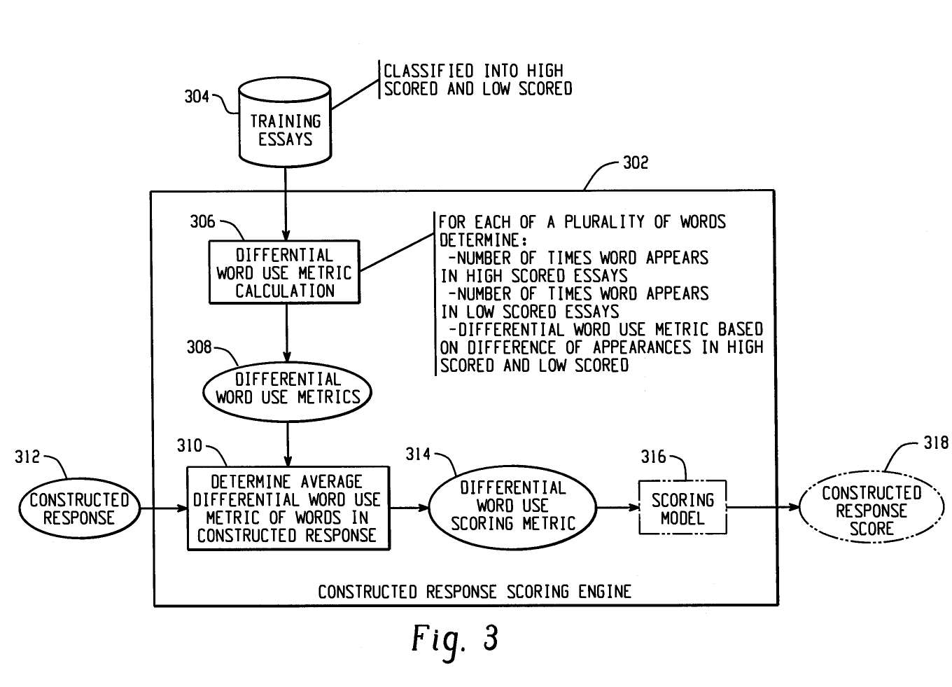

The system of FIG. 2, or variations of that system, can be used to generate a variety of scoring metrics that can provide indicators on the quality of a constructed response (e.g., on the content of the response, on the vocabulary used in the response). FIG. 3 is a block diagram depicting a computer-implemented method of scoring a constructed response using a differential word use metric. A differential word use metric is based on a comparison of the relative frequency of a word in essays of high quality versus essays of low quality (e.g., for essays scored on a six point scale, essays receiving scores of 6 and 5 are considered high quality and essays receiving scores of 2 and 1 are considered low quality). Such a metric is based on an assumption that the use of a word that appears more frequently in high-quality essays than in low-quality essays is an indicator of a stronger vocabulary.

The measure can be calculated by developing word indices for words appearing in high and low quality essays. For example, for each word (indexed i) encountered in a set of training essays (some words such as articles and prepositions may be removed from consideration), occurrences in a set of high-scored (fᵢₕ) and low-scored (fᵢₗ) essays are counted, and a differential word use metric is calculated by computing the differences of log-transformed relative frequencies of the word according to:

dᵢ=log(fᵢₕ/f_{•h})−log(fᵢₗ−f_{•l}),

where dᵢ is a differential word use metric for a word, fᵢₙ is the number of times the word appears in high scored essays, f_{•h} is the total number of words in the high scored essays, where fᵢₗ is the number of times the word appears in low scored essays, and f_{•l} is the total number of words in the low scored essays. A dᵢ value of zero indicates that a word is equally likely to appear in a low or high-scored constructed response. For an individual constructed response, a differential word use scoring metric can be computed based on an averaging of the dᵢ values over all the words in the constructed response.

With reference to FIG. 3, a constructed response scoring engine 302 receives a set of identified training essays 304 classified into high scoring essays and low scoring essays. At 306, for each of a plurality of words in the training essays 304, a number of times a word appears in a high scored essay is counted, and a number of times the word appears in low scored essays is counted. Further at 306, a differential word use metric is calculated for the word based on a difference in the number of times the word appears in high scored essays and the number of times the word appears in low scored essays. At 310, a differential word use metric value associated with each of a plurality of words in a constructed response 312 to be scored is identified. Those differential word use metric values are used to calculate a differential word use scoring metric 314 for the constructed response 312 based on an average of the differential word use metric values associated with the words in the constructed response 312.

The differential word use metric 314 provides a scoring metric option that can divorce the training essays from the particular constructed response being scored in whole or in part. In one example, training essays are essays that respond to the same prompt used to elicit the constructed response 312 to create a prompt-specific differential use scoring metric (PDWU). In another example, the training essays are essays that respond to a different prompt that is associated with a similar topic to create a task-level differential use scoring metric (TDWU). In a further example, the training essays are essays that respond to a different prompt or general textual data (e.g., published print media) without regard for topic. Such scoring metrics that are not dependent on training essays to the specific prompt associated with the constructed response 312 may be advantageous based on the desire for a high-turnover rate of prompts to ensure fair testing with minimized cheating possibilities.

The differential word use scoring metric 314 may be used alone to provide an indication of the quality of the constructed response 312, or the differential word use scoring metric 314 may be used in combination with other metrics (e.g., other content vector analysis (CVA) metrics) as inputs to a scoring model 316 for generating a constructed response score 318 (e.g., for use in calculating GRE or TOEFL examination essay scores).

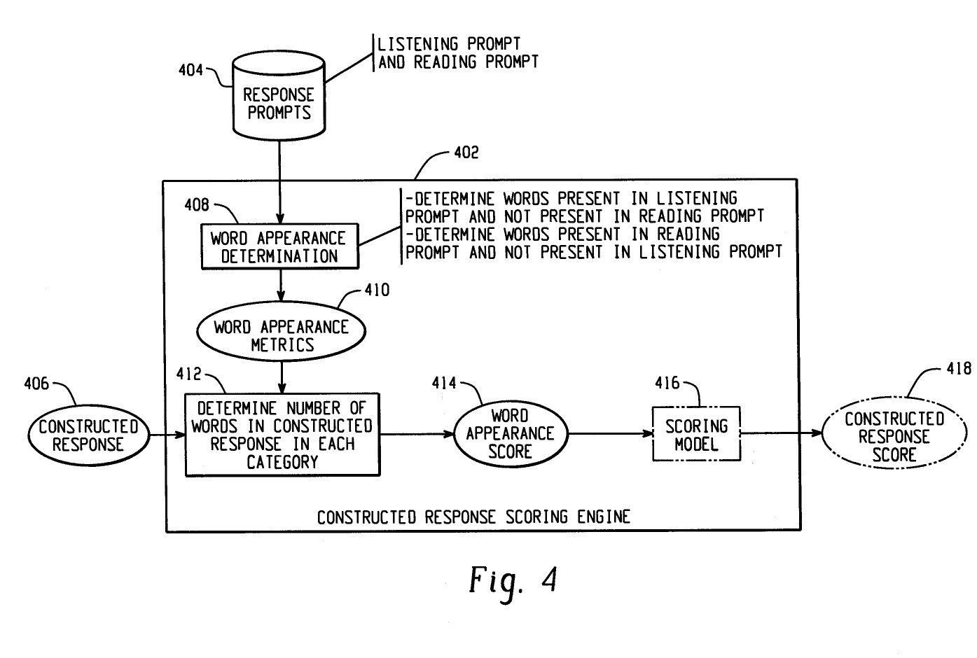

A constructed response scoring engine 402 may also be used to determine other metrics for scoring constructed responses. For example, FIG. 4 is a block diagram a computer-implemented method of scoring a constructed response using a word appearance metric. A word appearance metric is based on one or more prompts provided to an examinee to elicit a constructed response and may further be based on a model essay for the prompts. Like the differential word use metrics described above, such word appearance metrics may not rely on training essays to the specific prompts used to elicit the constructed response, enabling high prompt turnover rates.

A word appearance metric is determined at least in part based upon an overlap between words in a received constructed response and words appearing in listening and/or reading prompts provided to an examinee to elicit the constructed response. An overlap between words in the constructed response and words in a reading prompt tends to have a negative correlation with human scoring of the constructed response, as the examinee may simply copy the reading prompt or paraphrase the reading prompt without understanding or adding to the content of the reading prompt. In contrast, an overlap between words in the constructed response and words in a listening prompt tend to have a positive correlation with human scoring of the constructed response, as the use of words from a listening prompt indicates that the examinee heard and understood the words of the prompt, an especially relevant indicator in tests of non-native language abilities (e.g., a TOEFL exam). In another example, a word appearance metric is determined based upon an overlap between words in a constructed response and words appearing in a listening prompt and not a reading prompt and words appearing in the reading prompt and not the listening prompt. Such an approach removes any effect of words appearing in both prompts.

With reference to FIG. 4, a constructed response scoring engine 402 receives response prompts 404 in the form of listening prompts and/or reading prompts that are provided to an examinee to elicit a constructed response 406. The response prompts 404 are analyzed at 408 to generate word appearance metrics 410. For example, the analysis at 408 may determine a list of words present in a listening prompt and not present in a reading prompt as a listening-only words list, and the analysis at 408 may further determine a list of words present in the reading prompt but not present in the listening prompt as a reading-only words list. At 412, a determination is made as to the number of words in the constructed response 406 that are in each category. For example, the analysis at 412 may calculate a first number of words in the constructed response that appear on the listening-only list and a second number of words in the constructed response that appear on the reading-only list. A word appearance metric 414 is determined as a score for the constructed response 406 based on the first number and the second number, where the first number influences the score 414 positively and the second number influences the score 414 negatively. The word appearance score 414 may be utilized alone as an indicator of the quality of the constructed response 406, or the score 414 may be input to a scoring model 416 for use with other metrics to determine a constructed response score 418.

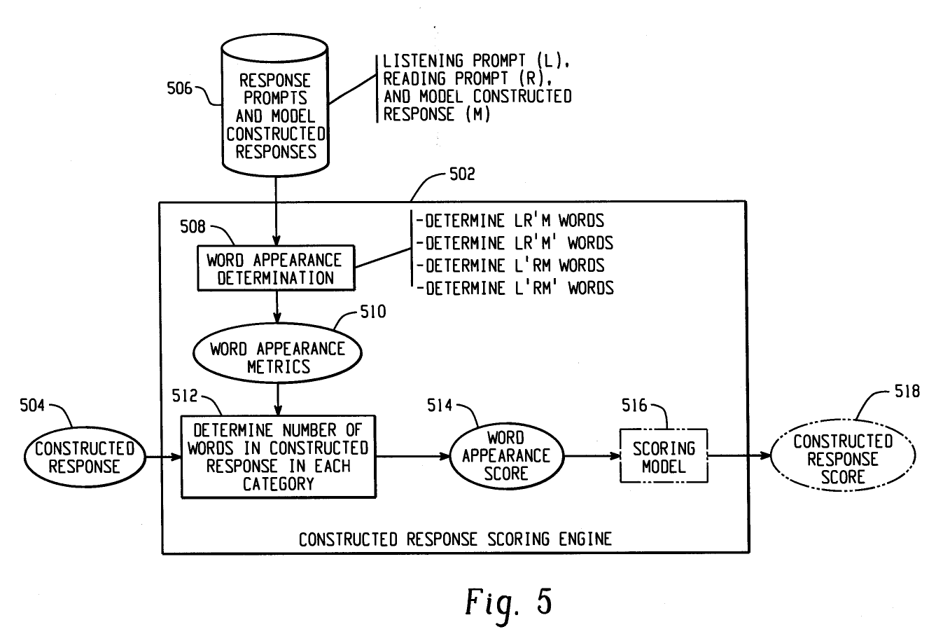

FIG. 5 is a block diagram a computer-implemented method of scoring a constructed response using a word appearance metric that considers a model response. In the example of FIG. 5, a constructed response scoring engine 502 considers whether words appear in a listening prompt, a reading prompt, and a model answer for the listening and reading prompts to determine a word appearance metric for judging the quality of a constructed response 504. The constructed response scoring engine 502 receives at 506 a listening prompt (L) and a reading prompt (R) provided to an examinee to elicit the constructed response 504. The scoring engine 502 further receives a model constructed response (M) for the listening and reading prompt pair, such as a model, high-scoring essay prepared by an expert.

At 508, the constructed response scoring engine 502 determines multiple words lists as word appearance metrics 510. The determination includes: an identification of words present in the listening prompt, not present in the reading prompt, and present in the model essay as an LR′M words list; an identification of words present in the listening prompt, not present in the reading prompt, and not present in the model essay as an LR′M′ words list; an identification of words not present in the listening prompt, present in the reading prompt, and present in the model essay as an L′RM words list; and an identification of words present in the not listening prompt, present in the reading prompt, and not present in the model essay as an L′RM′ words list. The word appearance metrics 510 are used to analyze the constructed response at 512 to generate the word appearance score 514. In one example, a first number of words in the constructed response that appear on the LR′M list is determined, a second number of words in the constructed response that appear on the LR′M′ list is determined, a third number of words in the constructed response that appear on the L′RM list is determined, and a fourth number of words in the constructed response that appear on the L′RM′ list is determined. A word appearance score 514 is determined based on the first number, the second number, the third number, and the fourth number, where the word appearance score 514 is positively affected by the first number and the second number and negatively affected by the third number and the fourth number (e.g., each of the numbers may be applied a weighting factor to generate the word appearance score 514). The word appearance score 514 may be utilized alone as an indicator of the quality of the constructed response 504, or the score 514 may be input to a scoring model 516 for use with other metrics to determine a constructed response score 518.

Additional scoring metrics can be derived and utilized based on manipulations of cosine correlations of constructed responses and groups of training texts. In one example where training essays are grouped according to a plurality of score points, cosine correlations are determined between a received constructed response and each group of training essays. The group with which the constructed response is deemed most highly correlated based on the cosine correlations is noted as an indication of the quality of the constructed response.

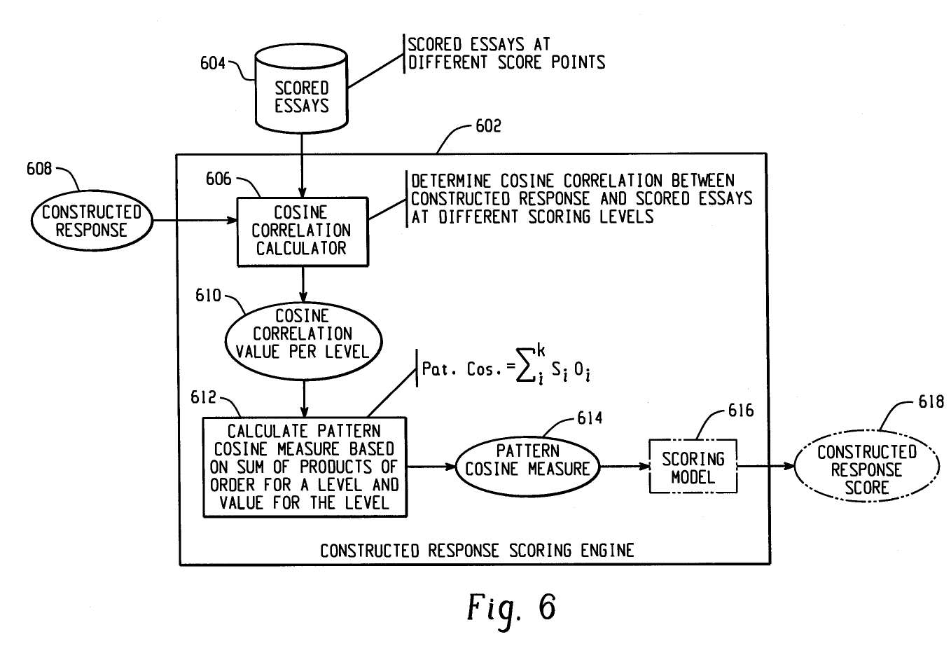

Additional benefit may be gained by utilizing the cosine correlation values associated with multiple or each of the groups of training essays. FIG. 6 is a block diagram depicting a determination of a pattern cosine measure based on a plurality of cosine correlation computations. A constructed response scoring engine 602 receives a set of training essays 604 that are classified into at least three scoring levels, wherein each of the scoring levels is associated with a value (e.g., the training essays are scored on a scale of 1, 2, 3, 4, 5, and 6). At 606, a received constructed response 608 is compared to the training essays 604 at each of the scoring levels to determine a cosine correlation value per level 610 indicating how similar the constructed response 608 is to training essays 604 that have already been scored at each of the multiple scoring levels.

At 612, a pattern cosine measure 614 is calculated based on the multiple cosine correlation values 610 determined at 606. For example, the levels (e.g., 1, 2, 3, 4, 5, 6) may be sorted according to the cosine correlation values 610 associated with those levels to determine an order of the levels. The pattern cosine measure may then be calculated based on a sum of products of the order (e.g., whether that level has the highest cosine correlation value 610, the second highest cosine correlation value, etc.) for a level and the value for that level according to:

Pat.Cos=Σᵢ^{k}SᵢOᵢ,

where k is the number of scoring levels, Sᵢ is the value of a level, and Oᵢ is the order of the level based on the cosine correlations 610. The pattern cosine value determined based on the sum of products may be utilized as an indicator of the quality of the constructed response. The pattern cosine measure 614 may also be normalized so that the pattern cosine value is on the same scale as the scale used to score the training essays 604. For example, for a six point scoring scale, the pattern cosine metric 614 can be normalized according to:

$$Pat . Cos . = \frac{{\sum }_{i}^{6} {S}_{i} {O}_{i} - 55}{6} ;$$

for a five point scoring scale, the pattern cosine metric 614 can be normalized according to:

$$Pat . Cos . = \frac{{\sum }_{i}^{5} {S}_{i} {O}_{i}}{5} - 6 ;$$

and for a four point scoring scale, the pattern cosine metric 614 can be normalized according to:

$$Pat . Cos . = {\sum }_{i}^{4} {S}_{i} {O}_{i} \times 0.3 - 5.$$

In the case of the five point scale normalization, a highest possible normalized pattern cosine value is a 5, and a lowest possible normalized pattern cosine value is a 1, matching the scale of 1 to 5. The pattern cosine measure 614 may be utilized alone as an indicator of the quality of the constructed response 608, or the measure 614 may be input to a scoring model 616 for use with other metrics to determine a constructed response score 618.

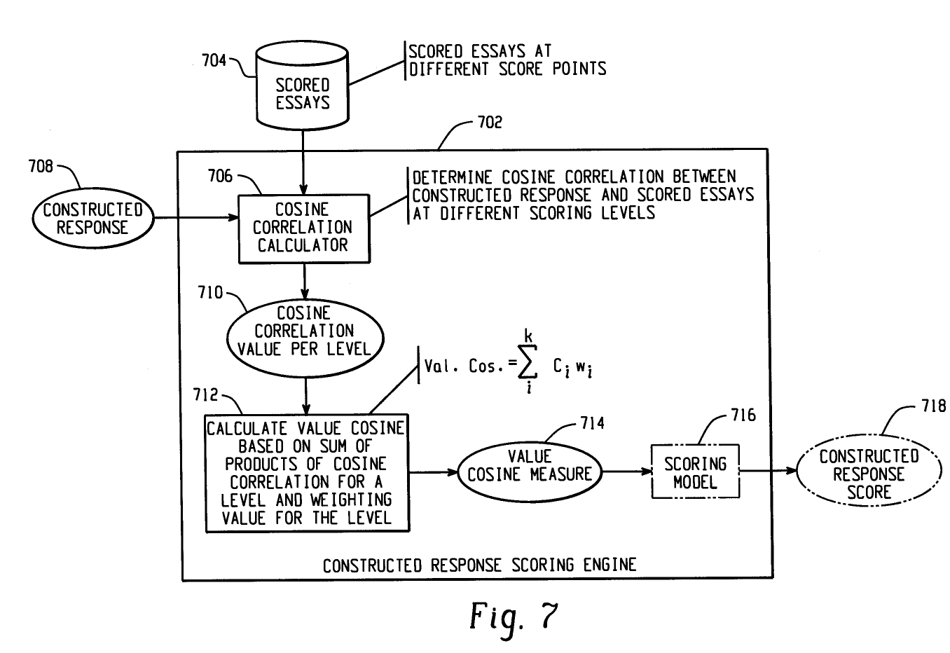

As an additional example, FIG. 7 is a block diagram depicting a determination of a value cosine measure based on a plurality of cosine correlation computations. A value cosine measure uses a weighted sum across a number of score points to indicate quality of a constructed response. For example, good score points (e.g., scores of 4 and 5 on a 5 point scale) are associated with positive weights, while lesser score points (e.g., scores of 3, 2, and 1) are associated with negative weights. Cosine correlations are determined between a constructed response to be scored and sets of training essays at each of the score points, and those determined correlations are weighted according to respective level weights and summed according to:

$$Val . Cos . = {{\sum }_{i}}^{k} {C}_{i} {w}_{i} ,$$

where Cᵢ is the calculated cosine correlation between the constructed response and training essays at score point i, and wᵢ is the weight at i. In one example, weights are assigned as follows:

Val. Cos.=C₆(1)+C₅(1)+C₄(1)+C₃(−1)+C₂(−1)+C₁(−1),

for a six-point scale. In another example, the highest score point is weighted at a value of 2 for a five-point scale as follows:

Val. Cos.=C₅(2)+C₄(1)+C₃(−1)+C₂(−1)+C₁(−1).

With reference to FIG. 7, a constructed response scoring engine 702 receives a set of training essays 704 that are classified into at least three scoring levels, wherein each of the scoring levels is associated with a value (e.g., the training essays are scored on a scale of 1, 2, 3, 4, 5, and 6). At 706, a received constructed response 708 is compared to the training essays 704 at each of the scoring levels to determine a cosine correlation value per level 710 indicating how similar the constructed response 708 is to training essays 704 that have already been scored at each of the multiple scoring levels.

At 712, a value cosine measure 714 is calculated based on the multiple cosine correlation values 710 determined at 706. For example, the cosine correlation values 710 for each level are multiplied by a pre-defined corresponding weight for that level. Those products are summed to generate the value cosine measure. The value cosine measure 714 may be utilized alone as an indicator of the quality of the constructed response 708, or the measure 714 may be input to a scoring model 716 for use with other metrics to determine a constructed response score 718.

Examples have been used to describe the invention herein, and the scope of the invention may include other examples. In one such example, misspelled words in a received constructed response may be corrected before being analyzed to improve scoring quality. In another example, certain words may be weighted based on their general frequency in a corpus of reference documents, such that more common words have less of an effect on a generated score. In a further example, scores may be adjusted based on the difficulty of a prompt provided for eliciting the constructed response.

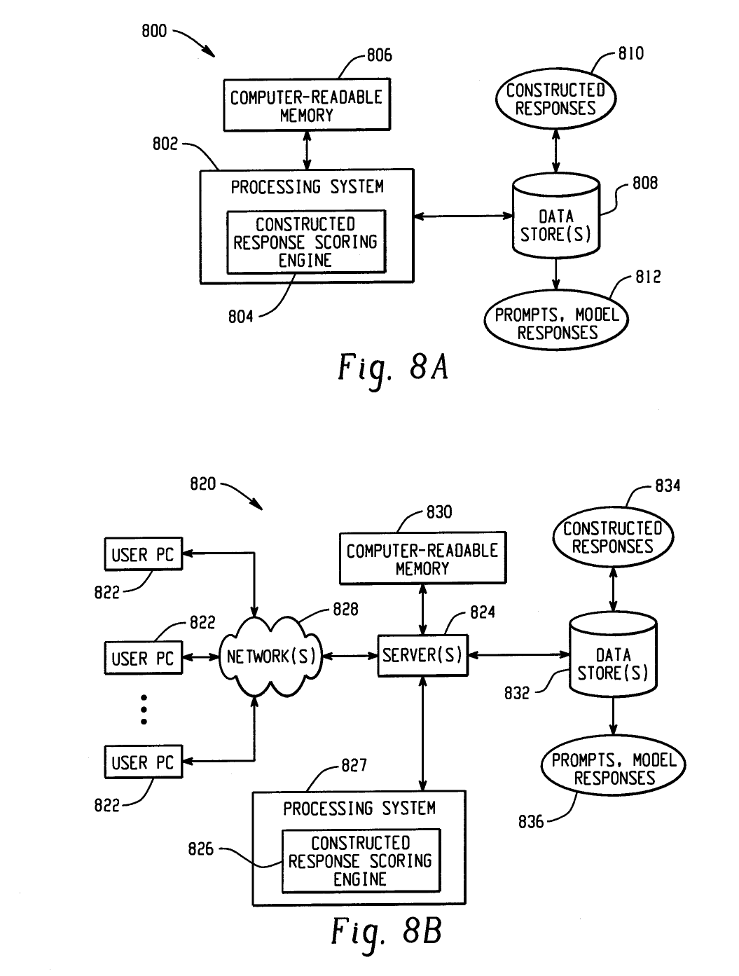

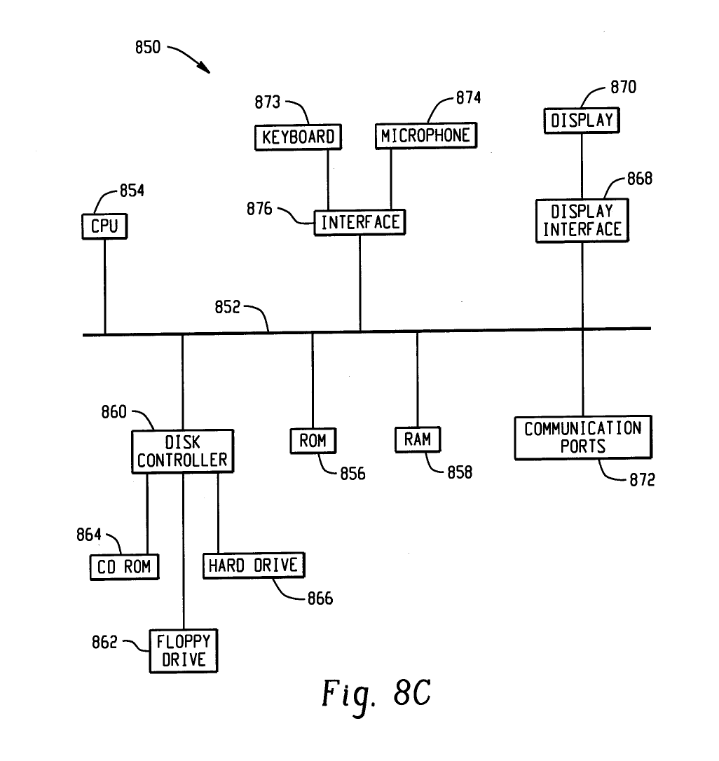

As another example, FIGS. 8A, 8B, and 8C depict example systems for use in implementing a constructed scoring engine. For example, FIG. 8A depicts an exemplary system 800 that includes a standalone computer architecture where a processing system 802 (e.g., one or more computer processors located in a given computer or in multiple computers that may be separate and distinct from one another) includes a constructed scoring engine 804 being executed on it. The processing system 802 has access to a computer-readable memory 806 in addition to one or more data stores 808. The one or more data stores 808 may include constructed response 810 as well as prompts and model responses 812.

FIG. 8B depicts a system 820 that includes a client server architecture. One or more user PCs 822 access one or more servers 824 running a constructed response scoring engine 826 on a processing system 827 via one or more networks 828. The one or more servers 824 may access a computer readable memory 830 as well as one or more data stores 832. The one or more data stores 832 may contain constructed responses 834 as well as prompts and model responses 836.

FIG. 8C shows a block diagram of exemplary hardware for a standalone computer architecture 850, such as the architecture depicted in FIG. 8A that may be used to contain and/or implement the program instructions of system embodiments of the present invention. A bus 852 may serve as the information highway interconnecting the other illustrated components of the hardware. A processing system 854 labeled CPU (central processing unit) (e.g., one or more computer processors at a given computer or at multiple computers), may perform calculations and logic operations required to execute a program. A non-transitory processor-readable storage medium, such as read only memory (ROM) 856 and random access memory (RAM) 858, may be in communication with the processing system 854 and may contain one or more programming instructions for performing the method of implementing a constructed response scoring engine. Optionally, program instructions may be stored on a non-transitory computer readable storage medium such as a magnetic disk, optical disk, recordable memory device, flash memory, or other physical storage medium.

A disk controller 860 interfaces one or more optional disk drives to the system bus 852. These disk drives may be external or internal floppy disk drives such as 862, external or internal CD-ROM, CD-R, CD-RW or DVD drives such as 864, or external or internal hard drives 866. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 860, the ROM 856 and/or the RAM 858. Preferably, the processor 854 may access each component as required.

A display interface 868 may permit information from the bus 852 to be displayed on a display 870 in audio, graphic, or alphanumeric format. Communication with external devices may optionally occur using various communication ports 872.

In addition to the standard computer-type components, the hardware may also include data input devices, such as a keyboard 873, or other input device 874, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method of scoring a constructed response, comprising:
identifying a set of training essays classified into high scored essays and low scored essays;
for each of a plurality of words in the essays of the training set:
counting a number of times a word appears in high scored essays;
counting a number of times the word appears in low scored essays;
calculating a differential word use metric for the word based on a difference in the number of times the word appears in high scored essays and the number of times the word appears in low scored essays;
identifying a differential word use metric value associated with each of a plurality of words in a constructed response to be scored; and
calculating a differential word use score for the constructed response based on the identified differential word use metrics, wherein the constructed response is given a score based on an average of the differential word use metric values for the constructed response.

2. The method of example 1, wherein the differential word use metric for a word, di, is calculated according to:
di=log(fᵢₕ/f_{•h})−log(fᵢₕ−f_{•1}),
where fᵢₕ is the number of times the word appears in high scored essays, f_{•h} is the total number of words in the high scored essays, where fᵢₗ is the number of times the word appears in low scored essays, and f_{•l} is the total number of words in the low scored essays.

3. The method of example 1, wherein the training essays are responses to a same prompt as the constructed response.

4. The method of example 1, wherein the training essays are responses to prompts on similar topics as a prompt for the constructed response.

5. The method of example 1, wherein the constructed response is a response for a GRE or TOEFL examination.

6. A computer-implemented method of scoring a constructed response that is provided in response to a dual prompt, wherein the dual prompt includes a listening prompt and a reading prompt, the method comprising:
identifying words present in the listening prompt and not present in the reading prompt as a listening-only words list;
identifying words present in the reading prompt and not present in the listening prompt as a reading-only words list;
determining a first number of words in the constructed response that appear on the listening-only list;
determining a second number of words in the constructed response that appear on the reading-only list;
determining a score for the constructed response based on the first number and the second number, wherein the first number influences the score positively and the second number influences the score negatively.

7. The example of claim 6, wherein the score is further based on whether words in the constructed response appear in a model text.

8. The method of claim 6, further comprising:
providing the listening prompt to an examinee;
providing the reading prompt to the examinee; and
receiving the constructed response from the examinee.

9. A computer-implemented method of scoring a constructed response that is provided in response to a dual prompt, wherein the dual prompt includes a listening prompt and a reading prompt, the method comprising:
identifying words present in the listening prompt, not present in the reading prompt, and present in a model essay as an LR′M words list;
identifying words present in the listening prompt, not present in the reading prompt, and not present in a model essay as an LR′M′ words list;
identifying words not present in the listening prompt, present in the reading prompt, and present in a model essay as an L′RM words list;
identifying words not present in the listening prompt, present in the reading prompt, and not present in a model essay as an L′RM′ words list;
determining a first number of words in the constructed response that appear on the LR′M list;
determining a second number of words in the constructed response that appear on the LR′M′ list;
determining a third number of words in the constructed response that appear on the L′RM list;
determining a fourth number of words in the constructed response that appear on the L′RM′ list;
determining a score for the constructed response based on the first number, the second number, the third number, and the fourth number.

10. The method of claim 9, wherein the score is affected positively by the first number and the second number, and wherein the score is affected negatively by the third number and the fourth number.

11. The method of claim 9, further comprising:
providing the listening prompt to an examinee;
providing the reading prompt to the examinee; and
receiving the constructed response from the examinee.

12. A computer-implemented method of scoring a constructed response, comprising:
identifying a set of training essays classified into at least three scoring levels, wherein each of the scoring levels is associated with a value;
calculating a cosine correlation between the constructed response and the training essays in each of the scoring levels;
ranking the cosine correlations for the scoring levels to identify an order for each level;
calculating a pattern cosine measure based on a sum of products of the order for a level and the value of the level;
determining a score for the constructed response based on the pattern cosine measure.

13. The method of example 12, wherein the pattern cosine measure is calculated according to:
Pat.Cos=Σᵢ^{k}SᵢOᵢ,
where Si is the value for a level and Oi is the order for the level.

14. The method of example 12, wherein the pattern cosine value is normalized to a scale of 1 to k, where k is the number of scoring levels.

15. A computer-implemented method of scoring a constructed response, comprising:
identifying a set of training essays classified into at least three scoring levels, wherein each of the scoring levels is associated with a weighting value;
calculating a cosine correlation between the constructed response and the training essays in each of the scoring levels;
calculating a value cosine measure based on a sum of products of the cosine correlation for a level and the weighting value of the level;
determining a score for the constructed response based on the pattern cosine measure.

16. The method of claim 15, wherein the training essays are classified into six scoring levels, wherein a three highest levels have a weighting value of 1 and a three lowest levels have a weighting value of −1.

17. The method of claim 15, wherein the training essays are classified into five scoring levels, wherein a two highest levels have a weighting value of 1 and a three lowest levels have a weighting value of −1.

18. The method of claim 15, wherein the training essays are classified into five scoring levels, wherein a highest level has a weighting value of two, a second highest level has a weighting value of 1, and a three lowest levels have a weighting value of −1.

19. A computer-implemented system for scoring a constructed response, comprising:
a processing system;
one or more computer-readable storage mediums containing instructions configured to cause the processing system to perform operations including:
identifying a set of training essays classified into high scored essays and low scored essays;
for each of a plurality of words in the essays of the training set:
counting a number of times a word appears in high scored essays;
counting a number of times the word appears in low scored essays;
calculating a differential word use metric for the word based on a difference in the number of times the word appears in high scored essays and the number of times the word appears in low scored essays;
identifying a differential word use metric value associated with each of a plurality of words in a constructed response to be scored; and
calculating a differential word use score for the constructed response based on the identified differential word use metrics, wherein the constructed response is given a score based on an average of the differential word use metric values for the constructed response.

20. A computer program product for scoring a constructed response, tangibly embodied in a machine-readable non-transitory storage medium, including instructions configured to cause a processing system to execute steps that include:
identifying a set of training essays classified into high scored essays and low scored essays;
for each of a plurality of words in the essays of the training set:
counting a number of times a word appears in high scored essays;
counting a number of times the word appears in low scored essays;
calculating a differential word use metric for the word based on a difference in the number of times the word appears in high scored essays and the number of times the word appears in low scored essays;
identifying a differential word use metric value associated with each of a plurality of words in a constructed response to be scored; and
calculating a differential word use score for the constructed response based on the identified differential word use metrics, wherein the constructed response is given a score based on an average of the differential word use metric values for the constructed response.
